(19) United States
(12) Patent Application Publication
(10) Pub. No.: US 2015/0170204 A1
(43) Pub. Date: Jun. 18, 2015

(54) MEANS AND METHODS FOR PROVIDING MARKETING INFORMATION

(71) Applicant: MINTEYE LTD., Tel Aviv (IL)

(72) Inventor: Shay Inbar, Tel Aviv (IL)

(21) Appl. No.: 14/413,794

(22) PCT Filed: Jul. 9, 2013
(86) PCT No.: PCT/IL13/00059

§ 371 Date: Jan. 9, 2015

Related U.S. Application Data
(60) Provisional application No. 61/670,146, filed on Jul. 11, 2012.

(51) Int. Cl. G06Q 30/02; G06F 21/36

(52) U.S. Cl. CPC G06Q 30/0257; G06F 21/36

(57) ABSTRACT

The present invention provides a system for providing marketing information comprising: a. at least one server adapted to host: (i) at least one video file; and (it) at least one CAPTCHA adapted to display marketing information; b. at least one screen in communication with at least one server; at least one screen displays at least one video file; wherein at least one CAPTCHA is accessible via the display at at least one point in time prior to end of display of the video-file; further wherein the successful completion of the CAPTCHA results in skipping the display of remainder of at least one video-file.

### FIELD OF THE INVENTION

The present invention generally relates to the field of marketing, more specifically, it relates to the field of providing marketing information while watching an online video.

### BACKGROUND OF THE INVENTION

The “Completely Automated Public Turing Test to tell Computers and Humans Apart” (CAPTCHATM) is a type of challenge-response test used in computing to determine that the response is not generated by a computer, and especially not by internet robots (bots). The process involves one computer (a server) asking a user to complete a simple test which the computer is able to generate and grade. Because other computers are unable to solve the CAPTCHA, any user entering a correct solution is presumed to be human user. A set of patent applications were filed by Yahoo! Inc., including “System and Method for Providing Semantic Captchas for Online Advertising (US20080133347A1)”; “System and Method for Delivering Online Advertisements Using Captchas (US20080133348A1)”; and “System and Method for Measuring Awareness of Online Advertising Using Captchas (US20080133331A1).” The general scope of those three inventions is a system and a method for using captchas for online advertising, specifically by storing a question about the advertisement along with a valid answer for use in verifying a user has received an impression of the advertisement. Those disclosers define a computer system for online advertising. The system comprises a CAPTCHA selector for selecting a CAPTCHA with an embedded advertisement for display as part of a web page. Those inventions utilize static CAPTCHAs, namely motionless, stationary and unchanging graphics including an image of one or more words that are distorted in order to make it difficult for an automated agent or machine process to decipher, but easy for a human to decipher.

With the increasing sophistication of computers and computer software, the ability of CAPTCHA-type programs to prevent unauthorized access by use computer-generated responses has lessened, and new methods are needed to make it more difficult for computers to produce responses that will fool the CAPTCHA-type program. PCT patent application PCT/IL2009/000589 to Ads Captcha has provided one example of such a new method (“TruSafe”), in which rather than simple input of text is required to gain entry to a web site, a larger degree of interaction (e.g. through identification of a picture) is needed.

Commercial television broadcasting has been supported by advertising revenue since its inception. More recently, providers of video programs and video clips in Internet sites have embedded advertising within video programs or next to video programs in web pages at which the video programs are viewed. However, a continuing problem involved in these technologies is that the advertisements are not closely personalized for the viewer. Instead, commercial broadcasters attempt to define, in terms of rough demographic characteristics, a sub-population of a mass audience that is expected to be interested in a particular program; advertisers who believe that their products appeal to the same rough demographic will purchase advertising slots in the program. Unfortunately, a continuing result of this system is that at least some viewers, who do not fit the rough demographic, are shown advertisements that are irrelevant to the viewers' interests.

Video editors such as Adobe Premiere Pro and Final Cut Pro enable users to select multiple video clips, join the clips, and annotate the clips by defining cue points and associating text notes with the cue points.

Thus, development of a CAPTCHA-type program that is seen by the user as being enjoyable and also enabling him to skip an online unwanted long-first advertisement posted prior or during displaying a video file remains a long-felt and unmet need.

### SUMMARY OF THE INVENTION

It is one object of the current invention to disclose a system for providing marketing information comprising:
a. at least one server adapted to host: (i) at least one video file; and (ii) at least one CAPTCHA adapted to display marketing information;
b. at least one screen in communication with at least one server; at least one screen displays at least one video file;
wherein at least one CAPTCHA is accessible via the display at at least one point in time prior to end of display of the video-file; further wherein the successful completion of the CAPTCHA results in skipping the display of remainder of at least one video-file.

It is another object of the current invention to disclose the system as described above, wherein either one of (i) at least one video file; and (ii) at least one CAPTCHA are residing on different servers.

It is another object of the current invention to disclose the system as described above, wherein the CAPTCHA is a puzzle.

It is another object of the current invention to disclose the system as described above, wherein pieces of the puzzle are movable by a method selected from a group consisting of: pressing an area of at least one screen; moving along at least one screen, moving a bar along at least one screen and a combination thereof.

It is another object of the current invention to disclose the system as described above, where the server receives notification of display of the marketing information.

It is another object of the current invention to disclose the system as described above, wherein the server counts time of the part of at least one video file, which was skipped.

It is another object of the current invention to disclose the system as described above, additionally comprising an automatic poll system; the poll system is for result of a marketing campaign using the marketing information.

It is another object of the current invention to disclose the system as described above, wherein the server selects at least one CAPTCHA according to a parameter selected from a group consisting of: location, gender, age, history of internet usage, and any other parameter indicating profile of user of the screen.

It is another object of the current invention to disclose the system as described above, wherein the CAPTCHA comprising interactive elements.

It is another object of the current invention to disclose the system as described above, wherein the marketing information is related to at least one video file.

It is another object of the current invention to disclose the system as described above, wherein the marketing information is part of at least one video file.

It is another object of the current invention to disclose the system as described above, wherein unsuccessful completion of the CAPTCHA is followed by returning to at least one video file.

It is another object of the current invention to disclose the system as described above, wherein sound of at least one video file is either played or not played during CAPTCHA completion.

It is another object of the current invention to disclose the system as described above, wherein the CAPTCHA is a web widget or a logic circuit configured to display different types of alternative short advertisements.

The system of claim 1, wherein the CAPTCHA is in a form of a plug-in installed in the video file or coupled with a hardware dongle.

It is another object of the current invention to disclose the system as described above, wherein the CAPTCHA is superimposed on at least one video file.

It is another object of the current invention to disclose the system as described above, wherein the server includes means for determining the geographical location of the screen.

It is another object of the current invention to disclose the system as described above, wherein the server further includes means for determining the local language spoken in geographical location of the screen.

It is another object of the current invention to disclose the system as described above, wherein the CAPTCHA comprises predetermined image derived from at least one video file.

It is another object of the current invention to disclose the system as described above, wherein the CAPTCHA is configured to display a short version of at least one video file.

It is another object of the current invention to disclose the system as described above, wherein the skipping is by either one of: (i) using a cursor for clicking a Skip button; (ii) using a cursor for delayed displaying of the CAPTCHA for a predetermined time.

It is another object of the current invention to disclose the system as described above, wherein interaction with the CAPTCHA, cursor or portions thereof are rotatable; trans locatable in either planar 2D or spatial 3D; magnifiable (zooming in) or miniaturable (zooming out); either 2D or 3D distortable; color, shade, transparency, focus and texture regulable; or any combination thereof.

It is another object of the current invention to disclose the system as described above, wherein interaction with the CAPTCHA is selected from a group consisting of virtual pressing, sustaining, leveraging, pulling, pushing, opening, closing, capturing, grasping, sliding, rolling, turning, coding, decoding, emitting sounds or vibrations, locking, unlocking, switching, drawing a pattern, scratching, rubbing, shooting, stabbing, piercing, pinning, indicating, typing, directing and otherwise manipulating the cursor within the CAPTCHA.

It is another object of the current invention to disclose the system as described above, wherein the CAPTCHA is characterized in comprising a picture or photograph missing at least one section and a representation of the missing section; the CAPTCHA is completed upon the missing portion is placed in its proper location, thus completing the picture or photograph.

It is another object of the current invention to disclose the system as described above, wherein the marketing information is displayed in a randomly selected place within the screen.

It is another object of the current invention to disclose the system as described above, wherein the CAPTCHA is characterized by being out of focus; the CAPTCHA is complete by focusing it.

It is another object of the current invention to disclose the system as described above, characterized in that representation of the CAPTCHA is randomly selected from a database of visual components.

It is another object of the current invention to disclose the system as described above, characterized in that representation of the CAPTCHA is a photograph.

It is another object of the current invention to disclose the system as described above, wherein the screen is constructed in a mobile device.

It is another object of the current invention to disclose the system as described above, wherein the mobile device is selected from a group consisting of cellular telephone; an iPhone; and a Blackberry.

It is another object of the current invention to disclose the system as described above, wherein the accessing the CAPTCHA is via a GUI.

It is another object of the current invention to disclose the system as described above, wherein the CAPTCHA requires dragging at least part of a picture to a predetermined location of the screen.

It is one object of the current invention to disclose a method for skipping a video file/providing marketing information comprising steps of:
a. displaying at least one video file on a display;
b. communicating between (i) the display; and (ii) a server containing at least one CAPTCHA displaying marketing information;
wherein the method additionally comprising steps of:
c. accessing via the display, at least one CAPTCHA at at least one point in time prior to ending of step (a);
d. solving at least one CAPTCHA displaying marketing information; and
e. skipping the display of remainder of at least one video-file.

It is another object of the current invention to disclose the method as described above, additionally comprising step of residing either one of (i) at least one video file; and (ii) at least one CAPTCHA on different servers.

It is another object of the current invention to disclose the method as described above, wherein the CAPTCHA is a puzzle.

It is another object of the current invention to disclose the system as described above, additionally comprising step of moving pieces of the puzzle by a method selected from a group consisting of: pressing an area of at least one screen; moving along at least one screen, moving a bar along at least one screen and a combination thereof.

It is another object of the current invention to disclose the method as described above, additionally comprising step of receving by the server notification of display of the marketing information.

It is another object of the current invention to disclose the method as described above, additionally comprising step of counting time of the part of at least one video file, which was skipped by the server.

It is another object of the current invention to disclose the method as described above, additionally comprising an automatic poll system; the poll system is for result of a marketing campaign using the marketing information.

It is another object of the current invention to disclose the method as described above, additionally comprising step of selecting by the server at least one CAPTCHA according to a parameter selected from a group consisting of: location, gender, age, history of internet usage, and any other parameter indicating profile of user of the screen.

It is another object of the current invention to disclose the method as described above, wherein the CAPTCHA comprising interactive elements.

It is another object of the current invention to disclose the method as described above, wherein the marketing information is related to at least one video file.

It is another object of the current invention to disclose the method as described above, wherein the marketing information is part of at least one video file.

It is another object of the current invention to disclose the method as described above, wherein unsuccessful completion of the CAPTCHA is followed by returning to at least one video file.

It is another object of the current invention to disclose the method as described above, wherein sound of at least one video file is either played or not played during CAPTCHA completion.

It is another object of the current invention to disclose the method as described above, wherein the CAPTCHA is a web widget or a logic circuit configured to display different types of alternative short advertisements.

The system of claim 1, wherein the CAPTCHA is in a form of a plug-in installed in the video file or coupled with a hardware dongle.

It is another object of the current invention to disclose the method as described above, additionally comprising step of superimposing the CAPTCHA on at least one video file.

It is another object of the current invention to disclose the method as described above, additionally comprising step of including in the server means for determining the geographical location of the screen.

It is another object of the current invention to disclose the method as described above, additionally comprising step of including means in the server for determining the local language spoken in geographical location of the screen.

It is another object of the current invention to disclose the method as described above, wherein the CAPTCHA comprises predetermined image derived from at least one video file.

It is another object of the current invention to disclose the method as described above, additionally comprising step of configuring the CAPTCHA to display a short version of at least one video file.

It is another object of the current invention to disclose the method as described above, wherein the skipping is by either one of: (i) using a cursor for clicking a Skip button; (ii) using a cursor for delayed displaying of the CAPTCHA for a predetermined time.

It is another object of the current invention to disclose the method as described above, wherein interaction with the CAPTCHA, cursor or portions thereof are rotatable; trans locatable in either planar 2D or spatial 3D; magnifiable (zooming in) or miniaturable (zooming out); either 2D or 3D distortable; color, shade, transparency, focus and texture regulable; or any combination thereof.

It is another object of the current invention to disclose the method as described above, wherein interaction with the CAPTCHA is selected from a group consisting of virtual pressing, sustaining, leveraging, pulling, pushing, opening, closing, capturing, grasping, sliding, rolling, turning, coding, decoding, emitting sounds or vibrations, locking, unlocking, switching, drawing a pattern, scratching, rubbing, shooting, stabbing, piercing, pinning, indicating, typing, directing and otherwise manipulating the cursor within the CAPTCHA.

It is another object of the current invention to disclose the method as described above, wherein the CAPTCHA is characterized in comprising a picture or photograph missing at least one section and a representation of the missing section; the CAPTCHA is completed upon the missing portion is placed in its proper location, thus completing the picture or photograph.

It is another object of the current invention to disclose the method as described above, additionally comprising step of displaying the marketing information in a randomly selected place within the screen.

It is another object of the current invention to disclose the method as described above, wherein the CAPTCHA is characterized by being out of focus; the CAPTCHA is complete by focusing it.

It is another object of the current invention to disclose the method as described above, additionally comprising step of randomly selecting representation of the CAPTCHA from a database of visual components.

It is another object of the current invention to disclose the method as described above, characterized in that representation of the CAPTCHA is a photograph.

It is another object of the current invention to disclose the method as described above, wherein the screen is constructed in a mobile device.

It is another object of the current invention to disclose the method as described above, wherein the mobile device is selected from a group consisting of cellular telephone; an iPhone; and a Blackberry.

It is another object of the current invention to disclose the method as described above, additionally comprising step of accessing the CAPTCHA via a GUI.

It is another object of the current invention to disclose the method as described above, wherein the CAPTCHA requires dragging at least part of a picture to a predetermined location of the screen.

### BRIEF DESCRIPTION OF THE DRAWINGS

In order to understand the invention and to see how it may be implemented in practice, a few preferred embodiments will now be described, by way of non-limiting example only, with reference to be accompanying drawings, in which:

FIG. 1 shows a block diagram for a system for presenting marketing information;

FIG. 2 illustrates a flow chart for a method for presenting marketing information;

FIGS. 3 and 4 describes a CAPTCHA in different positions; and

FIGS. 5a-c shows a CAPTCHA at different stages of solution.

### DETAILED DESCRIPTION OF THE INVENTION

The following description is provided so as to enable any person skilled in the art to make use of the invention and sets forth examples contemplated by the inventor of carrying out this invention. Various modifications, however, will remain apparent to those skilled in the art, since the generic principles of the present invention have been defined specifically. Also, it is to be understood that the phraseology and terminology employed herein is for the purpose of description and should not be regarded as limiting.

As used herein, the term “TruSafe” refers in general to a dynamic CAPTCHA system and method as described in PCT patent application PCT/IL2009/000589, which is incorporated by reference in its entirety. The essence of the TruSafe system is a two-dimensional (2D) or a three-dimensional (3D) configuration transformation (here, e.g., a change of a GUI-based item, such as CAPTCHA) over time. A dynamic CAPTCHA conceptually differs from a commercially available and static CAPTCHA known in the art. In such a static CAPTCHA, the configuration (location, orientation etc) of the GUI item is static, i.e., is not transformed and not changed during the time it is used. In most cases, preset symbols, usually text, are added to a predefined location within the item.

The planar or spatial transformation and planar/spatial change is associated with one or more of the following re-configuring actions of the TruSafe or portions thereof: e.g., rotating; trans-locating in either planar 2D or spatial 3D; magnifying (zooming in) or miniaturizing (zooming out); either 2D or 3D distorting; coloring; shading; making transparent; focusing and texturing or any combination thereof.

In its basic mode, a TruSafe comprises (a) a representation within said GUI; (b) a cursor operable by a human; and (c) at least one cursor sensitive zone (CSZ), said cursor and CSZ adapted to interact according to human perceptive response over time and space, and thus transform said TruSafe from its initial entrance-LOCKED configuration (in which skipping the first-long-advertisement is not possible) to at least one different terminal entrance-OPENED configuration (in which skipping is possible).

The present invention provides an improved version of such a TruSafe system and method, wherein the improvement comprises use of a representation comprising a pixel configuration modified from the native configuration of said representation.

As used herein, the terms “random” and “randomly” are used to refer interchangeably to events or sequences that are determined by the output of a true random number generator, or from a pseudo-random number generator.

As used herein, the term “representation” refers to any two- or three-dimensional object that appears within a GUI and is intended to illustrate an object that is recognizable to a user of the GUI. Non-limiting examples of representations include reproductions of pictures, photographs, drawings, three-dimensional objects, text, etc.

As used herein, the terms “picture” and “photograph,” when referring to a representation, refer to a digitized picture or photograph presented within the GUI (e.g. an on-screen reproduction of a photograph is considered, for purposes of the invention herein disclosed, to be a photograph).

As used herein, with respect to a representation the term “native configuration” refers to the configuration of the representation as it appears in the source image or object from which it is taken.

Non-limiting examples of representations not in their “native configuration” include pictures in which part of the picture is missing, displaced, distorted, or appears with a different focus or zoom; representations in which the total number of pixels cannot be related to the source object without distortion; etc.

As used herein, with reference to a representation, the term “visual component” refers to any portion of the representation that is intended to present non-textual information. Non-limiting examples of a visual component according to this definition include pictures, photographs, drawings, representations of three-dimensional objects, etc.

Research shows that 16%-24% of users click away from a site when they face PreRoll ads. The current invention skip Pre Roll ad allow publishers to reduce sites bounce rate while monetize the skip feature of the Pre Roll video. These ads give audiences the choice to slide while engaging with a new ad and skip directly to a designated content.

This gives audience a choice while still allowing advertisers to have measurable engagement.

Less than 30% of all Pre Roll ads hit their target. Consumers open new tabs, skip, usually occupy themselves with other things, leave the room, look through their social media sites, or just ignore ad that is played in front of them, meaning there is zero eye contact with the Pre Roll ad.

Instead of losing an opportunity to communicate with audience, the current invention “Skip Pre Roll Ad” gives consumers the choice to slide and assemble the image, engage with the brand, and skip directly to the content they requested. Users save time, while getting a positive experience with the brand.

The innovative “Pre Roll SKIP AD” creates the perfect balance between the users' urge to skip pre roll ads, and the insurance that the user will still engage with the Brand's message in the most favorable light.

In some embodiments of the current invention, the CAPTCHA which shows up during running if the video file, is compatible with all video formats and with all means for displaying video files (different browsers, different plugins, etc). At some embodiments the edges of the CAPTCHA will be blurred in order to reduce a possible misfit of the CAPTCHA to the video file upon it is superimposed.

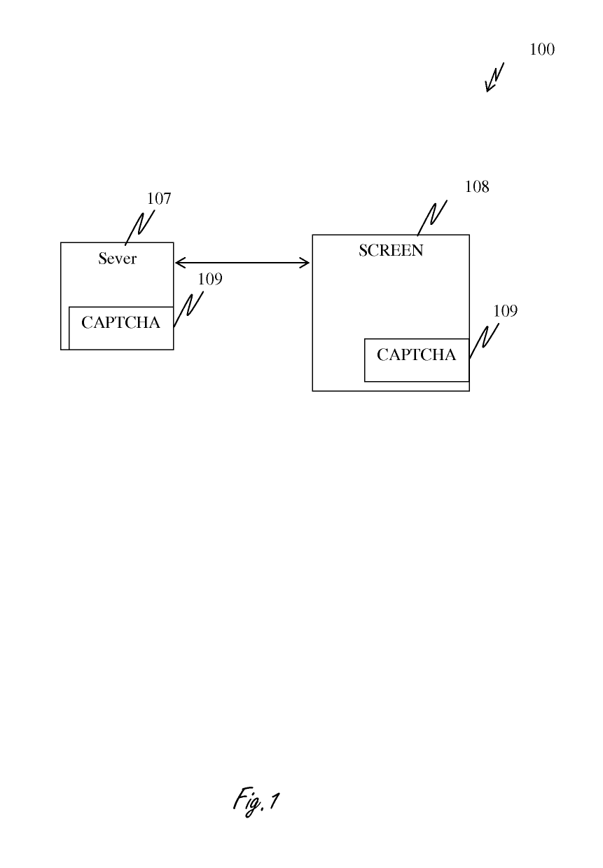

Reference is now made to FIG. 1, illustrating in a non-limiting manner at least one embodiment of a system for providing marketing information comprising:
a. at least one server 107 adapted to host: (i) at least one video file; and (ii) at least one CAPTCHA 109 adapted to display marketing information;
b. at least one screen 108 in communication with at least one server 107; at least one screen 107 displays at least one video file;
   wherein at least one CAPTCHA 109 is accessible via the screen 108 at at least one point in time prior to end of display of the video-file; further wherein the successful completion of the CAPTCHA 109 results in skipping the display of remainder of at least one video-file.

By using the above system, it is possible to get an active reaction from the user. While the user is passively watching a video-file, a CAPTCHA pops-up, this is considered a game. The user than needs to actively solve the CAPTCH and it will grant him the option of skipping the long video file, which otherwise he would have to watch (for example, a commercial before a movie).

This CAPTCHA can be superimposed on the original video, enhancing the user experience as being part of the video that is being played. The CAPTCHA will be constructed on any video format, and in case of misfit, other measurements will be taken to reduce it (e.g. blurring the borders of the CAPTCHA to make it look as it fits the video size).

In some embodiments of the current invention, the system as described above, wherein either one of (i) at least one video file; and (ii) at least one CAPTCHA are residing on different servers.

In some embodiments of the current invention, the system as described above, wherein the CAPTCHA is a puzzle.

In some embodiments of the current invention, the system as described above, wherein pieces of the puzzle are movable by a method selected from a group consisting of: pressing an area of at least one screen; moving along at least one screen, moving a bar along at least one screen and a combination thereof.

In some embodiments of the current invention, the system as described above, where the server receives notification of display of the marketing information.

In some embodiments of the current invention, the system as described above, wherein the server counts time of the part of at least one video file, which was skipped.

In some embodiments of the current invention, the system as described above, additionally comprising an automatic poll system; the poll system is for result of a marketing campaign using the marketing information.

In some embodiments of the current invention, the system as described above, wherein the server selects at least one CAPTCHA according to a parameter selected from a group consisting of: location, gender, age, history of internet usage, and any other parameter indicating profile of user of the screen.

In some embodiments of the current invention, the system as described above, wherein the CAPTCHA comprising interactive elements.

In some embodiments of the current invention, the system as described above, wherein the marketing information is related to at least one video file.

In some embodiments of the current invention, the system as described above, wherein the marketing information is part of at least one video file.

In some embodiments of the current invention, the system as described above, wherein unsuccessful completion of the CAPTCHA is followed by returning to at least one video file.

In some embodiments of the current invention, the system as described above, wherein sound of at least one video file is either played or not played during CAPTCHA completion.

In some embodiments of the current invention, the system as described above, wherein the CAPTCHA is a web widget or a logic circuit configured to display different types of alternative short advertisements.

The system of claim 1, wherein the CAPTCHA is in a form of a plug-in installed in the video file or coupled with a hardware dongle.

In some embodiments of the current invention, the system as described above, wherein the CAPTCHA is superimposed on at least one video file.

In some embodiments of the current invention, the system as described above, wherein the server includes means for determining the geographical location of the screen.

In some embodiments of the current invention, the system as described above, wherein the server further includes means for determining the local language spoken in geographical location of the screen.

In some embodiments of the current invention, the system as described above, wherein the CAPTCHA comprises predetermined image derived from at least one video file.

In some embodiments of the current invention, the system as described above, wherein the CAPTCHA is configured to display a short version of at least one video file.

In some embodiments of the current invention, the system as described above, wherein the skipping is by either one of: (i) using a cursor for clicking a Skip button; (ii) using a cursor for delayed displaying of the CAPTCHA for a predetermined time.

In some embodiments of the current invention, the system as described above, wherein interaction with the CAPTCHA, cursor or portions thereof are rotatable; trans locatable in either planar 2D or spatial 3D; magnifiable (zooming in) or miniaturable (zooming out); either 2D or 3D distortable; color, shade, transparency, focus and texture regulable; or any combination thereof.

In some embodiments of the current invention, the system as described above, wherein interaction with the CAPTCHA is selected from a group consisting of virtual pressing, sustaining, leveraging, pulling, pushing, opening, closing, capturing, grasping, sliding, rolling, turning, coding, decoding, emitting sounds or vibrations, locking, unlocking, switching, drawing a pattern, scratching, rubbing, shooting, stabbing, piercing, pinning, indicating, typing, directing and otherwise manipulating the cursor within the CAPTCHA.

In some embodiments of the current invention, the system as described above, wherein the CAPTCHA is characterized in comprising a picture or photograph missing at least one section and a representation of the missing section; the CAPTCHA is completed upon the missing portion is placed in its proper location, thus completing the picture or photograph.

In some embodiments of the current invention, the system as described above, wherein the marketing information is displayed in a randomly selected place within the screen.

In some embodiments of the current invention, the system as described above, wherein the CAPTCHA is characterized by being out of focus; the CAPTCHA is complete by focusing it.

In some embodiments of the current invention, the system as described above, characterized in that representation of the CAPTCHA is randomly selected from a database of visual components.

In some embodiments of the current invention, the system as described above, characterized in that representation of the CAPTCHA is a photograph.

In some embodiments of the current invention, the system as described above, wherein the screen is constructed in a mobile device.

In some embodiments of the current invention, the system as described above, wherein the mobile device is selected from a group consisting of cellular telephone; an iPhone; and a Blackberry.

In some embodiments of the current invention, the system as described above, wherein the accessing the CAPTCHA is via a GUI.

In some embodiments of the current invention, the system as described above, wherein the CAPTCHA requires dragging at least part of a picture to a predetermined location of the screen.

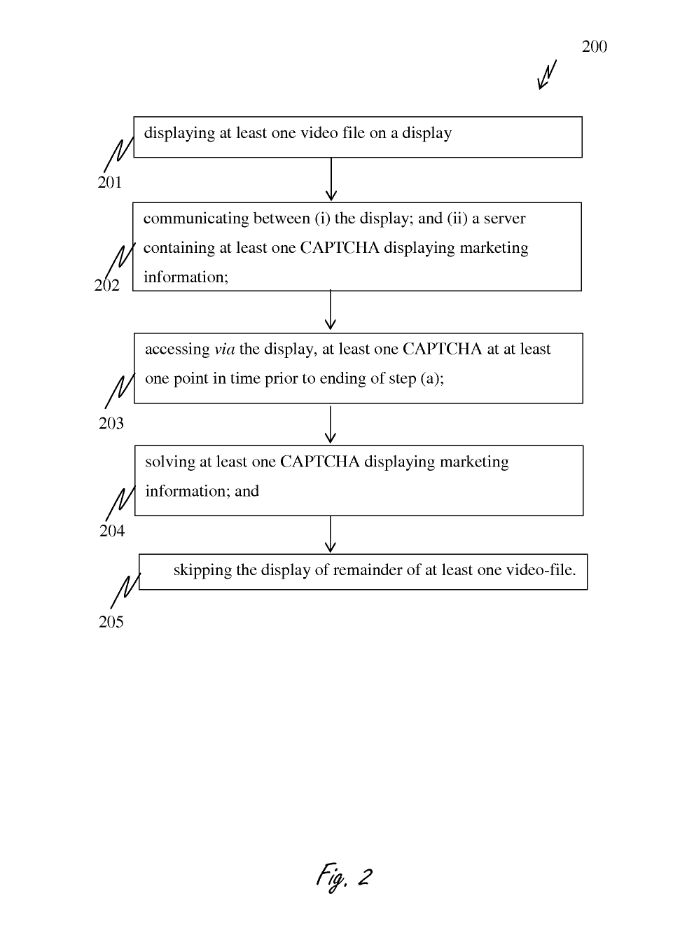

Reference is now made to FIG. 2, illustrating in a non-limiting manner a method 200 for skipping a video file/providing marketing information comprising:
a. step 201 of displaying at least one video file on a screen;
b. step 202 of communicating between (i) the screen; and (ii) a server containing at least one CAPTCHA displaying marketing information;
wherein the method additionally comprising steps of:
c. step 203 of accessing via the screen, at least one CAPTCHA at at least one point in time prior to ending of step (a);
d. step 204 of solving at least one CAPTCHA displaying marketing information; and
e. step 205 of skipping the display of remainder of at least one video-file.

In some embodiments of the current invention, the method as described above, additionally comprising step of residing either one of (i) at least one video file; and (ii) at least one CAPTCHA on different servers.

In some embodiments of the current invention, the method as described above, wherein the CAPTCHA is a puzzle.

In some embodiments of the current invention, the system as described above, additionally comprising step of moving pieces of the puzzle by a method selected from a group consisting of: pressing an area of at least one screen; moving along at least one screen, moving a bar along at least one screen and a combination thereof.

In some embodiments of the current invention, the method as described above, additionally comprising step of receving by the server notification of display of the marketing information.

In some embodiments of the current invention, the method as described above, additionally comprising step of counting time of the part of at least one video file, which was skipped by the server.

In some embodiments of the current invention, the method as described above, additionally comprising an automatic poll system; the poll system is for result of a marketing campaign using the marketing information.

In some embodiments of the current invention, the method as described above, additionally comprising step of selecting by the server at least one CAPTCHA according to a parameter selected from a group consisting of: location, gender, age, history of internet usage, and any other parameter indicating profile of user of the screen.

In some embodiments of the current invention, the method as described above, wherein the CAPTCHA comprising interactive elements.

In some embodiments of the current invention, the method as described above, wherein the marketing information is related to at least one video file.

In some embodiments of the current invention, the method as described above, wherein the marketing information is part of at least one video file.

In some embodiments of the current invention, the method as described above, wherein unsuccessful completion of the CAPTCHA is followed by returning to at least one video file.

In some embodiments of the current invention, the method as described above, wherein sound of at least one video file is either played or not played during CAPTCHA completion.

In some embodiments of the current invention, the method as described above, wherein the CAPTCHA is a web widget or a logic circuit configured to display different types of alternative short advertisements.

The system of claim 1, wherein the CAPTCHA is in a form of a plug-in installed in the video file or coupled with a hardware dongle.

In some embodiments of the current invention, the method as described above, additionally comprising step of superimposing the CAPTCHA on at least one video file.

In some embodiments of the current invention, the method as described above, additionally comprising step of including in the server means for determining the geographical location of the screen.

In some embodiments of the current invention, the method as described above, additionally comprising step of including means in the server for determining the local language spoken in geographical location of the screen.

In some embodiments of the current invention, the method as described above, wherein the CAPTCHA comprises predetermined image derived from at least one video file.

In some embodiments of the current invention, the method as described above, additionally comprising step of configuring the CAPTCHA to display a short version of at least one video file.

In some embodiments of the current invention, the method as described above, wherein the skipping is by either one of: (i) using a cursor for clicking a Skip button; (ii) using a cursor for delayed displaying of the CAPTCHA for a predetermined time.

In some embodiments of the current invention, the method as described above, wherein interaction with the CAPTCHA, cursor or portions thereof are rotatable; trans locatable in either planar 2D or spatial 3D; magnifiable (zooming in) or miniaturable (zooming out); either 2D or 3D distortable; color, shade, transparency, focus and texture regulable; or any combination thereof.

In some embodiments of the current invention, the method as described above, wherein interaction with the CAPTCHA is selected from a group consisting of virtual pressing, sustaining, leveraging, pulling, pushing, opening, closing, capturing, grasping, sliding, rolling, turning, coding, decoding, emitting sounds or vibrations, locking, unlocking, switching, drawing a pattern, scratching, rubbing, shooting, stabbing, piercing, pinning, indicating, typing, directing and otherwise manipulating the cursor within the CAPTCHA.

In some embodiments of the current invention, the method as described above, wherein the CAPTCHA is characterized in comprising a picture or photograph missing at least one section and a representation of the missing section; the CAPTCHA is completed upon the missing portion is placed in its proper location, thus completing the picture or photograph.

In some embodiments of the current invention, the method as described above, additionally comprising step of displaying the marketing information in a randomly selected place within the screen.

In some embodiments of the current invention, the method as described above, wherein the CAPTCHA is characterized by being out of focus; the CAPTCHA is complete by focusing it.

In some embodiments of the current invention, the method as described above, additionally comprising step of randomly selecting representation of the CAPTCHA from a database of visual components.

In some embodiments of the current invention, the method as described above, characterized in that representation of the CAPTCHA is a photograph.

In some embodiments of the current invention, the method as described above, wherein the screen is constructed in a mobile device.

In some embodiments of the current invention, the method as described above, wherein the mobile device is selected from a group consisting of cellular telephone; an iPhone; and a Blackberry.

In some embodiments of the current invention, the method as described above, additionally comprising step of accessing the CAPTCHA via a GUI.

In some embodiments of the current invention, the method as described above, wherein the CAPTCHA requires dragging at least part of a picture to a predetermined location of the screen.

According to one embodiment of the present invention the TruSafe graphical user interface is used for entertainment usages. In other words, the TruSafe graphical user interface is utilized as a ‘barrier’ prior to enabling the user to skip the displaying of a first-long-advertisement which display prior or during displaying a video file.

It is further an object of the present invention to provide the TruSafe graphical user interface for entertainment usages. In other words, the TruSafe graphical user interface is utilized as a ‘barrier’ prior to enabling the user to e.g. enter, download, view, purchase or any other act. For example the TruSafe graphical user interface can be used as a gate prior to enabling a user to download movies, songs, articles, clisp et cetera.

According to another embodiment, a business model is utilized. Namely, payment of the advertiser of fees once a user transforms TruSafe from its initial entrance-LOCKED configuration to the terminal entrance-OPENED configuration which provide the complete view of the alternative-short-advertisement.

It is in the scope of the invention wherein the cursor and the CSZ are adapted to interact. The terms “interact” and “interaction” refer herein interchangeably in a non-limiting manner to a two-dimensional (2D) or a three-dimensional (3D) configuration transformation of the CSZ or portions thereof along the time of using the TruSafe.

It is also in the scope of the invention wherein the interaction is provided by a human perceptive response over time and space. A user activates the cursor. The activation is provided by any suitable manner, e.g., by use of hands, voice, eye indications, etc.

The activation is facilitated by conscious and willful human response. According to one preferred embodiment of the invention, a propioceptic(either 2D or 3D) human perceptive response, e.g., an eye-hand (computer mouse) propioceptic response.

It is also in the scope of the invention wherein the interaction over space of the CSZ, cursor or portions thereof is one or more of the following: rotatable; translocable in either planar 2D or spatial 3D; magnifiable (zooming in) or miniaturable (zooming out); either 2D or 3D distortable; color, shade, transparency, focus and texture regulable; or any combination thereof.

It is also in the scope of the invention wherein the interaction as defined in any of the above is selected from a group consisting of e.g., virtual pressing, sustaining, leveraging, pulling, pushing, opening, closing, capturing, grasping, sliding, rolling, turning, coding, decoding, emitting sounds or vibrations, locking, unlocking, switching, drawing a pattern, scratching, rubbing, shooting, stabbing, piercing, pinning, indicating, typing, directing or otherwise manipulating the cursor within the CSZ.

It is also in the scope of the invention wherein the TruSafe as defined in any of the above is used for displaying advertisements and brands. According to these embodiments of the invention, the initial entrance-LOCKED symbol configuration; at least one terminal entrance-OPENED symbol configuration or intermediates thereof provides an advertisement or a representation of a complete advertisement.

In some embodiments of the invention, the representation of a complete advertisement comprises predetermined image derived from said first long advertisement and display a short version brief of the first long advertisement.

In preferred embodiments of the invention, the representation of a complete advertisement is configured to display a short version of said first long advertisement.

In some embodiments of the invention, it comprises means for determining the geographical location of the computer from which input is being requested or at least the server through which the computer is connected to the Internet. Means for making this sort of determination are well-known in the art, e.g. by checking the IP address of the computer from which entry is being sought, from which the location of the computer can be determined. Similarly, in some embodiments of the invention, these or similar means are used to determine the local language of the location of the computer from which input is expected. These means can also be used to determine or at least estimate the native language of the person trying to gain entry, either from the location of the computer or server, or from a set of preferences provided by the user.

The advantage of these embodiments in which the location of the user's computer is determined can include provisions for directing advertising to the user that is appropriate to the geographical location of the user, e.g., an advertiser can direct that advertising material be distributed only to those countries in which the advertiser's product is actually sold.

In preferred embodiments of the improved TruSafe herein disclosed, the representation comprises one or more of a representation comprising a pixel configuration modified from the native configuration of the representation.

In preferred embodiments of the invention, the representation is designed based on our understanding of cognitive abilities of humans that enable them to understand visual cues in ways that as yet are impossible for computers. In one set of embodiments, the pixel configuration is modified in the simplest possible manner: a predetermined number of pixels are added or subtracted from the source representation. By changing the number of pixels by a relatively small amount (e.g. by removing a small number of pixels from one edge of the background), the picture will no longer exactly match the source representation. Thus, a computer searching a database of known pictures will be unable to locate the representation presented within the TruSafe GUI, and will be unable to match any subsequent manipulations necessary for transformation of the TruSafe's configuration from entrance-LOCKED to entrance-OPENED. Similarly, embodiments of the TruSafe are disclosed in which the color (e.g. RGB values) of a predetermined number of pixels within the representation are changed from those of its native configuration. In one such embodiment, a grid of changed color values is presented, for example, in the background of a picture within the representation. In preferred embodiments, only minor changes in the RGB values are performed, so that to the human eye, the color appears to be substantially correct over the entire representation. Even so, a computer is much less likely to be able to match the representation with one in an existing database, since the RGB values no longer match.

In some embodiments of the invention, the TruSafe comprises a representation that is missing at least one section, with the missing section presented in the GUI separated from the remainder of the representation. The same representation (e.g. a picture that serves as an advertisement) can be shown to each user who wants to display a video file, or it can be chosen either sequentially or randomly from a list. The CSZ includes an actuator (e.g. a slider) that is used to manipulate the missing piece of the representation. When the missing piece is moved to the correct location and orientation, completing the picture, the configuration is transformed from entrance-LOCKED to entrance-OPENED.

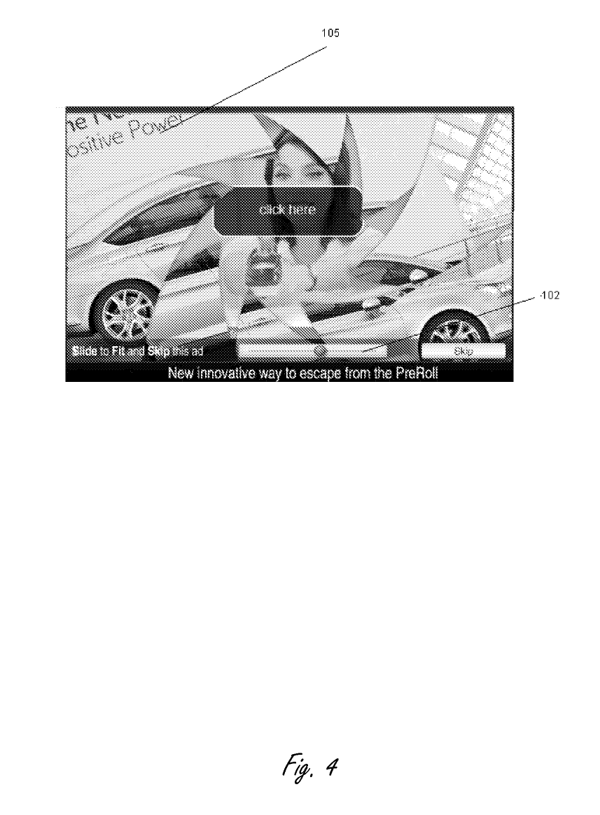

Reference is now made to FIG. 4, which illustrates non-limiting examples of typical embodiments provides an example of representation comprises a picture or photograph displace at least one section 105. In embodiments that comprise displace section of picture or photograph, the feedback expected from the user comprises an interactive element 102 (e.g. a slider or movement of the cursor) that causes further distortion in one direction but restoration of the native configuration of the visual component in the other. When the user has restored the picture to its native configuration, the TruSafe is transformed from the entrance-LOCKED configuration to the entrance-OPENED configuration.

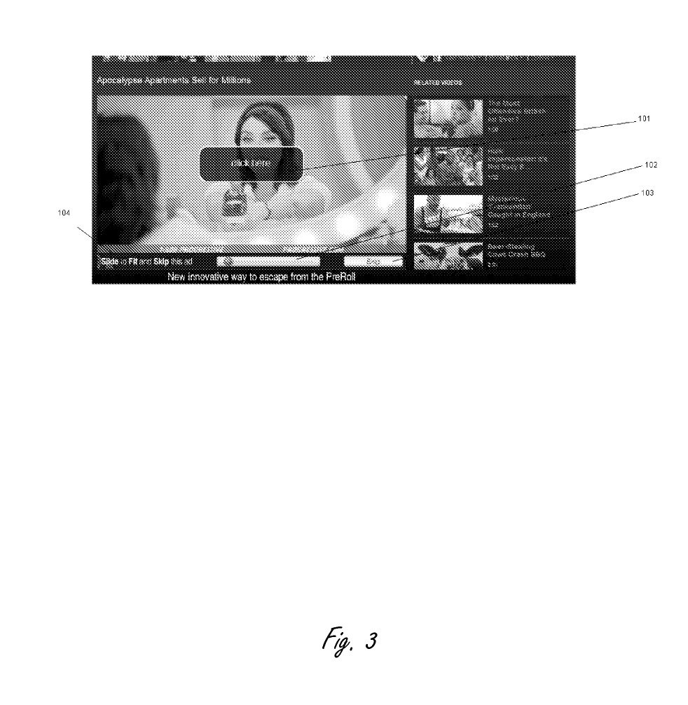

Reference is now made to FIG. 3, which illustrates an example of a first-long-advertising displayed prior to the video file 101 before the user interacts with the slider 102. Actuator 102 is presented within the GUI (in these examples, the actuator is a slider; any actuator known in the art may be used). According to the instructions displayed on the screen (104) the user uses the cursor (e.g. from a mouse) to activate the actuator. Activation of the actuator configured to displays an alternative short advertisement 105 superimposing on long-first-advertosement101.

When the user believes that the displaced portion is placed in its proper location, thus completing the picture or photograph, the cursor is used to click Skip button 103 or delayed the displaying of the complete picture or photograph for predetermined time or alternatively for any predetermined action.

If the user has correctly manipulated the displaced section of the representation such that the representation is corrected, the TruSafe is transformed from the entrance-LOCKED configuration to the entrance-OPENED configuration, and skippingthe long-first-advertising is allowed. Any embodiment in which the transformation is effected by manipulation of a displaced or missing section of a representation is referred to herein as a “correct the picture” embodiment.

Other “correct the picture” embodiments are within the scope of the invention. For example, the GUI can comprise a picture in which a portion is out-of-context or presented in the incorrect color, such that the manipulator is used to restore the correct portion or to restore the color to that consistent with the remainder of the representation (e.g. moving a slider changes one or more of the RGB values of the relevant pixels).

In another embodiment, the out-of-context portion of the representation comprises a section presented at a different zoom, and the manipulator is used to magnify or diminish that portion of the representation until it matches the zoom of the remainder. In yet another embodiment, the out-of-context portion of the representation is out of focus with respect to the remainder of the representation, and the manipulator is used to bring that portion into focus.

Other “correct the picture” embodiments are within the scope of the invention. For example, blurring of part of the region out-of-context portion. In the embodiment illustrated, the blurring is accomplished by dividing the region into blocks comprising a plurality of pixels on a side, and averaging the color within each block (effectively lowering the resolution of the picture). The human eye can still identify the slice that must be translated in order to correct the representation, even though there is no longer a sharp transition between the out-of-context slice and the remainder of the picture that could be identified by a computer.

In some embodiments of the invention, rather than blurring or dislocating part of the visual component, the entire visual component is subject to distortion. An example of such a distorted visual component. In embodiments that comprise such a distorted picture or photograph, the feedback expected from the user comprises an interactive element (e.g. a slider or movement of the cursor) that causes further distortion in one direction but restoration of the native configuration of the visual component in the other. When the user has restored the picture to its native configuration, the TruSafe is transformed from the entrance-LOCKED configuration to the entrance-OPENED configuration.

All of the embodiments of the invention disclosed herein share a common property of being more game-like than typical CAPTCHA programs, as the user is provided with a representation that is more interesting and more fun to look at than a simple collection of alphanumeric characters. Thus, it can be seen that the invention herein disclosed provides a useful solution to the above-described need for a CAPTCHA-type program that is felt by the user to be more enjoyable to use. Thus, in some embodiments, the TruSafe is used as an on-line game rather than for displaying a video file.

It is also within the scope of the invention to disclose an improved method for distinguishing between allowed human feedback and a disallowed computer-generated response. The method comprises steps of (a) obtaining at least one TruSafe GUI according to any of the embodiments disclosed in detail above; (b) providing said TruSafe with (i)a representation; (ii) a cursor operable by a human and (iii) at least one cursor sensitive zone (CSZ); (c) interacting, according to human perceptive response over time and space, said cursor and said CSZ; and (d) transforming said TruSafe from its initial entrance-LOCKED configuration to at least one terminal entrance-OPENED configuration. As explained above in the discussion of the TruSafe itself, the improvement comprises including within the step of providing said TruSafe with (i)a representation; (ii) a cursor operable by a human and (iii) at least one cursor sensitive zone (CSZ) a further step of providing a representation comprising a pixel configuration modified from the native configuration of said representation. By including such a step in the method, the likelihood that a computer-generated response will successfully transform the TruSafe from its initial entrance-LOCKED configuration to at least one terminal entrance-OPENED configuration is significantly reduced relative to CAPTCHA-type methods that lack such a step.

An example of a system and process for enabling a user to skip an online long-first advertisement posted prior and/or during displaying a video file, after viewing a TruSafeshort-alternative-advertisement. The following drawings and text describe various examples and implementations of the design. The system may contain one or more web pages of users with an embedded on-line video program

In one example of the current invention, a video is displayed, suddenly, at the 18 minute a CAPTCHA is superimposed on the video. If the user completes the CAPTCHA.

Solving the CAPTCHA can be done by a long press at a certain location on the screen (it is possible if a user has a touch screen or using the mouse in a computer). It can also be by a short press, dragging of a cursor along the screen etc.

The system identifies whether the CCAPTCHA was viewed, either by completion of it, or by skipping it. It will also monitor the time saved to the user by skipping the time of the remainder of the video file which was supposed to be played.

It is possible, in some embodiments, to pur different pictures in the same CAPTCHA. By doing so, a Banner is created which saves money of producing an expensive video-advertisement.

The CAPTCH itself, during its display (or at the end) may have links to different locations, either online, or constructed within the CAPTCHA.

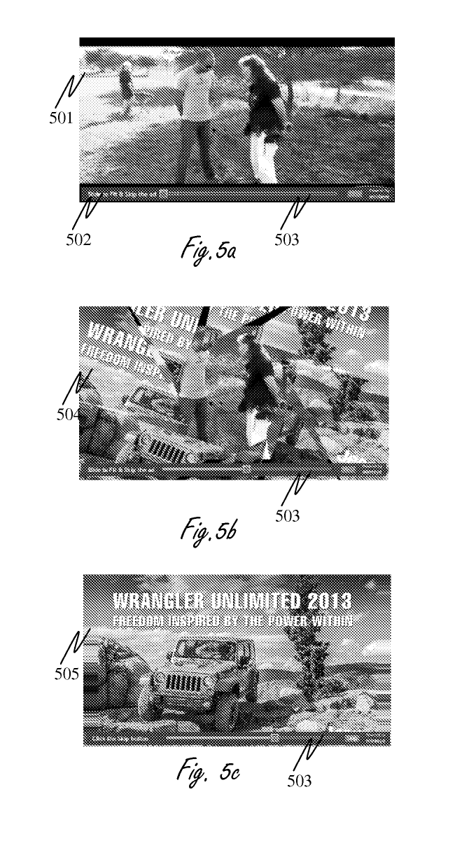

Reference is now made to FIGS. 5(a-c) illustrating in a non-limiting manner, at least one embodiment of the current invention showing a CAPTCHA at different stages. At first, as can be seen from FIG. 5a a video file 501 is presented, in the lower section there is an option 502 for “drag and skip” using a slider 503. In FIG. 5b, a CAPTCHA 504 now appears as the user moved along the slider 503, the CAPTCHA 504 is constructed from pieces of an image which moves as the user slides along the slider 503. At some point on the slider 503 (the point of solving the CAPTCHA), the pieces of the image will come together to form one complete image 505 as can be seen in FIG. 5c, thereby solving the CAPTCHA and skipping the video file 501.

It will be appreciated by persons skilled in the art that embodiment of the invention are not limited by what has been particularly shown and described hereinabove.

Rather the scope of at least one embodiment of the invention is defined by the claims below.

1-64. (canceled)

65. A system for providing marketing information comprising:
a. at least one server adapted to host: (i) at least one video file; and (ii) at least one CAPTCHA adapted to display marketing information; and
b. at least one screen in communication with said at least one server; said at least one screen displays said at least one video file,
wherein said at least one CAPTCHA is accessible via said screen at at least one point in time prior to end of display of said video-file; further wherein said successful completion of said CAPTCHA results in skipping said display of remainder of said at least one video-file.

66. The system according to claim 65, wherein either one of (i) said at least one video file; and (ii) said at least one CAPTCHA are residing on different servers.

67. The system according to claim 65, wherein said CAPTCHA is a puzzle; further wherein pieces of said puzzle are movable by a method selected from a group consisting of: pressing an area of said at least one screen; moving along said at least one screen, moving a bar along said at least one screen and and any combination thereof.

68. The system according to claim 65, wherein at least one of the following is being held true (a) said server receives notification of display of said marketing information; (b) said server counts time of the part of said at least one video file, which was skipped; (c) said server selects said at least one CAPTCHA according to a parameter selected from a group consisting of: location, gender, age, history of internet usage, and any other parameter indicating profile of user of said screen; (d) said system additionally comprising an automatic poll system; said poll system is for result of a marketing campaign using said marketing information; (e) said CAPTCHA comprising interactive elements; and any combination thereof.

69. The system according to claim 65, wherein at least one of the following is being held true (a) said marketing information is related to said at least one video file; (b)said marketing information is part of said at least one video file; (c) unsuccessful completion of said CAPTCHA is followed by returning to said at least one video file; (d) sound of said at least one video file is either played or not played during CAPTCHA completion; (e) said CAPTCHA is a web widget or a logic circuit configured to display different types of alternative short advertisements; (f)said CAPTCHA is in a form of a plug-in installed in the video file or coupled with a hardware dongle; (g) said CAPTCHA is superimposed on said at least one video file; and any combination thereof.

70. The system according to claim 65, wherein at least one of the following is being held true (a) said server includes means for determining the geographical location of said screen; (b) said server further includes means for determining the local language spoken in geographical location of said screen; (c) said CAPTCHA comprises predetermined image derived from said at least one video file; (d) said CAPTCHA is configured to display a short version of said at least one video file; (e) said CAPTCHA is characterized in comprising a picture or photograph missing at least one section and a representation of said missing section; said CAPTCHA is completed upon said missing portion is placed in its proper location, thus completing the picture or photograph; (f) said CAPTCHA is characterized by being out of focus; said CAPTCHA is complete by focusing it; (g) said marketing information is displayed in a randomly selected place within said screen; and any combination thereof.

71. The system according to claim 65, wherein said skipping is by either one of: (i) using a cursor for clicking a Skip button; (ii) using a cursor for delayed displaying of said CAPTCHA for a predetermined time.

72. The system according to claim 65, wherein interaction with said CAPTCHA, cursor or portions thereof are rotatable; trans locatable in either planar 2D or spatial 3D; magnifiable (zooming in) or miniaturable (zooming out); either 2D or 3D distortable; color, shade, transparency, focus and texture regulable; or any combination thereof.

73. The system according to claim 72, wherein interaction with said CAPTCHA is selected from a group consisting of virtual pressing, sustaining, leveraging, pulling, pushing, opening, closing, capturing, grasping, sliding, rolling, turning, coding, decoding, emitting sounds or vibrations, locking, unlocking, switching, drawing a pattern, scratching, rubbing, shooting, stabbing, piercing, pinning, indicating, typing, directing and otherwise manipulating said cursor within said CAPTCHA.

74. The system according to claim 65, wherein at least one of the following is being held true (a) said system is characterized in that representation of said CAPTCHA is randomly selected from a database of visual components; (b) said system is characterized in that representation of said CAPTCHA is a photograph; (c) said screen is constructed in a mobile device; (d) said accessing said CAPTCHA is via a GUI; (e) said CAPTCHA requires dragging at least part of a picture to a predetermined location of said screen; and any combination thereof.

75. A method for skipping a video file/providing marketing information comprising steps of:
a. displaying at least one video file on a screen;
b. communicating between (i) said screen; and (ii) a server containing at least one CAPTCHA displaying marketing information;
c. wherein said method additionally comprising steps of:
d. accessing via said screen, said at least one CAPTCHA at least one point in time prior to ending of step (a);
e. solving said at least one CAPTCHA displaying marketing information; and
f. skipping said display of remainder of said at least one video-file.

76. The method according to claim 75, additionally comprising step of residing either one of (i) said at least one video file; and (ii) said at least one CAPTCHA on different servers.

77. The method according to claim 75, wherein said CAPTCHA is a puzzle; further wherein said method additionally comprising step of moving pieces of said puzzle by a method selected from a group consisting of: pressing an area of said at least one screen; moving along said at least one screen, moving a bar along said at least one screen and a combination thereof.

78. The method according to claim 75, additionally comprising at least one step selected from a group consisting of (a) receiving by said server notification of display of said marketing information; (b) counting time of the part of said at least one video file, which was skipped by said server; (c) providing said system with an automatic poll system; said poll system is for result of a marketing campaign using said marketing information; (d) selecting by said server said at least one CAPTCHA according to a parameter selected from a group consisting of: location, gender, age, history of internet usage, and any other parameter indicating profile of user of said screen; (e) providing said CAPTCHA with an interactive elements; (f) said marketing information is related to said at least one video file; (g) said marketing information is part of said at least one video file; and any combination thereof.

79. The method according to claim 75, wherein at least one of the following is being held true (a) unsuccessful completion of said CAPTCHA is followed by returning to said at least one video file; (b)sound of said at least one video file is either played or not played during CAPTCHA completion; (c) said CAPTCHA is a web widget or a logic circuit configured to display different types of alternative short advertisements; (d) said CAPTCHA is in a form of a plug-in installed in the video file or coupled with a hardware dongle; (e) said CAPTCHA is characterized in comprising a picture or photograph missing at least one section and a representation of said missing section; said CAPTCHA is completed upon said missing portion is placed in its proper location, thus completing the picture or photograph; and any combination thereof.

80. The method according to claim 75, additionally comprising at least one step selected from a group consisting of (a) superimposing said CAPTCHA on said at least one video file; (b)including in said server means for determining the geographical location of said screen; (c) including means in said server for determining the local language spoken in geographical location of said screen; (d) providing said CAPTCHA with predetermined image derived from said at least one video file; (e) configuring said CAPTCHA to display a short version of said at least one video file; (f) accessing said CAPTCHA via a GUI; (g) displaying said marketing information in a randomly selected place within said screen; (h) randomly selecting representation of said CAPTCHA from a database of visual components; and any combination thereof.

81. The method according to claim 75, wherein said skipping is by either one of: (i) using a cursor for clicking a Skip button; (ii) using a cursor for delayed displaying of said CAPTCHA for a predetermined time.

82. The method according to claim 81, wherein interaction with said CAPTCHA, cursor or portions thereof are rotatable; trans locatable in either planar 2D or spatial 3D; magnifiable (zooming in) or miniaturable (zooming out); either 2D or 3D distortable; color, shade, transparency, focus and texture regulable; or any combination thereof.

83. The method according to claim 81, wherein interaction with said CAPTCHA is selected from a group consisting of virtual pressing, sustaining, leveraging, pulling, pushing, opening, closing, capturing, grasping, sliding, rolling, turning, coding, decoding, emitting sounds or vibrations, locking, unlocking, switching, drawing a pattern, scratching, rubbing, shooting, stabbing, piercing, pinning, indicating, typing, directing and otherwise manipulating said cursor within said CAPTCHA.

84. The method according to claim 75, wherein at least one of the following is being held true (a) said CAPTCHA is characterized by being out of focus; said CAPTCHA is complete by focusing it; (b) said system is characterized in that representation of said CAPTCHA is a photograph; (c) said screen is constructed in a mobile device; (d) said CAPTCHA requires dragging at least part of a picture to a predetermined location of said screen; and any combination thereof.
